(19) United States
(12) Patent Application Publication
(10) Pub. No.: US 2025/0245953 A1
(43) Pub. Date: Jul. 31, 2025

(54) FAST BOUNDING BOX HIERARCHY FORMATION

(71) Applicant: SAMSUNG ELECTRONICS CO., LTD., Gyeonggi-Do (KR)

(72) Inventors: Zhe Zhu, Irvine, CA (US); Tien-Cheng BAU, Tustin, CA (US)

(21) Appl. No.: 19/033,767

(22) Filed: Jan. 22, 2025

Related U.S. Application Data
(60) Provisional application No. 63/626,365, filed on Jan. 29, 2024.

(51) Int. Cl. G06V 10/25; G06V 10/26

(52) U.S. Cl. CPC G06V 10/25; G06V 10/267

(57) ABSTRACT

Bounding box merging and/or hierarchy formation includes mapping, by a hardware processor, 2-dimensional locations of a plurality of bounding boxes of a digital image to 1-dimensional locations. Distances between bounding box pairs sorted based on the 1-dimensional locations can be calculated. Entries may be stored, by a hardware processor, in a priority queue. The entries specify bounding box pairs and corresponding distances between the respective bounding box pairs. The plurality of bounding boxes may be represented as a binary search tree based on the 1-dimensional locations. The hardware processor reduces a number of the plurality of bounding boxes by merging a selected bounding box pair selected from the priority queue based on distance, wherein the merging creates a new bounding box.

### CROSS-REFERENCE TO RELATED APPLICATIONS

This application claims the benefit of U.S. Application No. 63/626,365 filed on Jan. 29, 2024, which is fully incorporated herein by reference.

### RESERVATION OF RIGHTS IN COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates to computer vision and, more particularly, to the formation of a bounding box hierarchy in support of image processing.

### BACKGROUND

In the field of computer vision technology, acquisition of bounding boxes provides useful information for performing image processing operations. In general, a bounding box is a rectangular shape having a particular location and dimensions within, or overlayed on, a digital image that defines a particular object of interest in the digital image. The bounding box typically encompasses the object of interest as recognized or detected in the digital image and, as such, defines the location and/or size of that object within the digital image. Examples of objects enumerated by bounding boxes may include, but are not limited to, text, vehicles, faces, human beings, and the like. For instance, bounding boxes may be used to enumerate text for purposes of text recognition, vehicles within traffic data, and/or other objects. The bounding boxes facilitate image processing functions such as object-specific analysis, object-specific region enhancement of the image, or other image processing functions.

In the usual case, bounding boxes may be generated by object detectors when processing a given digital image. Typically, a one-to-one relationship exists in that each bounding box enumerates a single object or instance of an object. For example, one bounding box may be generated for each vehicle detected in a digital image. In the case of text or character detection, one bounding box may be generated for each character that is detected. It may be seen that the number of bounding boxes generated in various contexts may be quite large. As each bounding box may require separate and/or independent processing, an image having a large number of bounding boxes may impose a substantial computational burden for a computing device. This is particularly true for computing devices with limited computing resources. This computational burden only increases in cases where real-time image processing and/or rendering is required.

To reduce the computational burden imposed on devices and/or to meet real-time processing requirements, the bounding boxes may be merged. Fewer bounding boxes through merger may preserve useful information as to the detected objects while allowing the device to meet performance requirements. A conventional brute force technique for merging bounding boxes to create a bounding box hierarchy from N bounding boxes will iterate N-1 times. Within each iteration, such techniques find two bounding boxes that have the minimum distance and merge those two bounding boxes. Because this technique iterates N-1 times and the distance between any two candidate bounding boxes is calculated for each iteration with a time complexity of O(N²), the overall time complexity of a conventional brute force bounding box merger technique becomes O(N³). A time complexity of O(N³) requires too much time for large values of N for a brute force technique to be of practical use in reducing the computational burden on a device, particularly devices with limited computing resources intended to operate in real-time.

### SUMMARY

In one or more embodiments, a method includes mapping, by a hardware processor, 2-dimensional locations of a plurality of bounding boxes of a digital image to 1-dimensional locations. The method includes calculating distances between bounding box pairs sorted based on the 1-dimensional locations. The method includes storing, by the hardware processor, entries in a priority queue. Each entry specifies a bounding box pair and a distance between the bounding box pair. The method includes representing, by the hardware processor, the plurality of bounding boxes as a binary search tree based on the 1-dimensional locations. The method includes reducing, by the hardware processor, a number of the plurality of bounding boxes by merging a selected bounding box pair selected from the priority queue based on distance. The merging creates a new bounding box.

In one or more embodiments, an apparatus includes a hardware processor configured to perform operations. The operations include mapping 2-dimensional locations of a plurality of bounding boxes of a digital image to 1-dimensional locations. The operations include calculating distances between bounding box pairs sorted based on the 1-dimensional locations. The operations include storing entries in a priority queue. Each entry specifies a bounding box pair and a distance between the bounding box pair. The operations include representing the plurality of bounding boxes as a binary search tree based on the 1-dimensional locations. The operations include reducing a number of the plurality of bounding boxes by merging a selected bounding box pair selected from the priority queue based on distance, wherein the merging creates a new bounding box.

In one or more embodiments, a computer program product includes one or more computer readable storage mediums and program instructions collectively stored on the one or more computer readable storage mediums. The program instructions are executable by computer hardware to initiate operations. The operations include mapping 2-dimensional locations of a plurality of bounding boxes of a digital image to 1-dimensional locations. The operations include calculating distances between bounding box pairs sorted based on the 1-dimensional locations. The operations include storing entries in a priority queue. Each entry specifies a bounding box pair and a distance between the bounding box pair. The operations include representing the plurality of bounding boxes as a binary search tree based on the 1-dimensional locations. The operations include reducing a number of the plurality of bounding boxes by merging a selected bounding box pair selected from the priority queue based on distance, wherein the merging creates a new bounding box.

This Summary section is provided merely to introduce certain concepts and not to identify any key or essential features of the claimed subject matter. Many other features and embodiments of the disclosed technology will be apparent from the accompanying drawings and from the following detailed description.

### BRIEF DESCRIPTION OF THE DRAWINGS

The accompanying drawings show one or more embodiments; however, the accompanying drawings should not be taken to limit the disclosed technology to only the embodiments shown. Various aspects and advantages will become apparent upon review of the following detailed description and upon reference to the drawings.

FIG. 1 illustrates an example of an image processing pipeline including a merge framework.

FIG. 2 illustrates a merge framework in accordance with one or more embodiments of the disclosed technology.

FIG. 3 illustrates a method of operation for a merge framework in accordance with one or more embodiments of the disclosed technology.

FIG. 4 illustrates an example implementation of a mapping process performed by a merger engine of a merger framework in accordance with one or more embodiments of the disclosed technology.

FIG. 5 illustrates a method of generating a bounding box hierarchy in accordance with one or more embodiments of the disclosed technology.

FIG. 6 is an example visual illustration of the generation of a bounding box hierarchy in accordance with one or more embodiments of the disclosed technology.

FIG. 7 illustrates an example of a data processing system 700 for use with one or more embodiments of the disclosed technology.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to computer vision and, more particularly, to the formation of a bounding box hierarchy in support of image processing. In accordance with one or more embodiments of the disclosed technology, methods, systems, and computer program products are disclosed for use with computer vision systems that reduce the number of bounding boxes in digital images. The embodiments of the disclosed technology reduce the number of bounding boxes by merging bounding boxes to create a bounding box hierarchy. The bounding box(es) remaining subsequent to the merging process may be processed as part of one or more image processing functions by a device using fewer computational resources and/or in less time than would otherwise be the case. In this manner, the embodiments of the disclosed technology facilitate real-time image processing operations and may be useful in resource-constrained devices.

In one or more embodiments, a system is capable of mapping 2-dimensional (2D) locations of a plurality of bounding boxes to 1-dimensional (1D) locations. The system is capable of calculating distances between pairs of the bounding boxes as sorted based on the 1D locations (e.g., sequentially). This reduces the number of distance calculations performed compared to other bounding box merger techniques such as brute force methods.

In one or more embodiments, the system utilizes various data structures for efficiently managing the merger operations. The system uses a priority queue for tracking and managing distances between bounding box pairs based on the 1D locations of the bounding boxes. Using the priority queue allows prioritized distances, e.g., the smallest or minimum distance between a pair of bounding boxes, to be readily selected and removed from the priority queue for merging. The system uses a binary search tree to represent the bounding boxes and/or bounding box hierarchy. The binary search tree facilitates efficient insertion of newly created bounding boxes from merger operations and/or deletion of bounding boxes that have been merged.

For purposes of illustration, a merger operation may be performed on a pair of bounding boxes by selecting a minimum distance from the priority queue. The system merges the two bounding boxes associated with the selected distance. The new bounding box created from the merger may be added to the binary search tree and the bounding boxes that were merged may be removed from the binary search tree. The system may determine a 1D coordinate for the newly created bounding box and a distance between the newly created bounding box and one or more neighbor bounding boxes of the newly created bounding box may be calculated based on the 1D coordinates. The distance(s) and associated bounding box pairs may be pushed onto the priority queue.

The operations generally described above may be repeated/iterated until a desired number of bounding boxes remains. The embodiments of the disclosed technology are capable of generating a bounding box hierarchy having a reduced number of bounding boxes and doing so in less time than other techniques. For example, mapping bounding boxes from 2D locations to 1D locations reduces the time and/or computational complexity of finding two candidate bounding boxes to be merged from O(N²) in the case of the brute force technique to O(logN). As such, the overall complexity of techniques in accordance with the disclosed technology have a time complexity of approximately O(NlogN) compared to the time complexity of a conventional brute force technique of O(N³). The reduction in time required to reduce the number of bounding boxes may be used in resource constrained devices and/or to facilitate real-time image processing in any of a variety of different devices including resource constrained devices.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

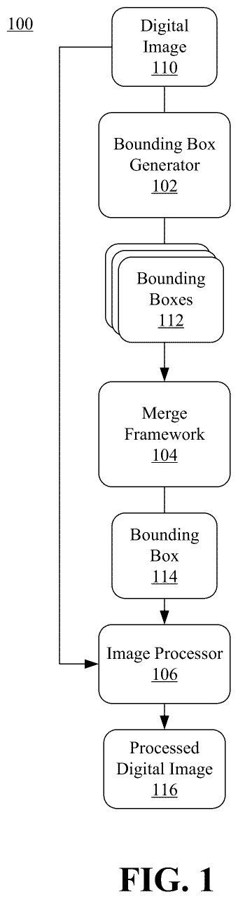

FIG. 1 illustrates an example of an image processing pipeline (pipeline) 100. Pipeline 100 is capable of processing digital images and generating processed versions of the digital images. The digital images processed through pipeline 100 may be one or more individual images and/or frames of video. Pipeline 100 is provided for purposes of illustration as an example use case where bounding box merger may be performed to improve computational efficiency and facilitate real-time operation. The example of FIG. 1 is not intended as a limitation of the embodiments of the disclosed technology.

For purposes of illustration, pipeline 100 may be implemented in any of a variety of different devices that implement or utilize computer vision. Such devices may utilize bounding boxes that define objects and locations and/or sizes of the objects within digital images. Examples of devices that may utilize the methods, systems, and computer program products described herein in accordance with the disclosed technology may include, but are not limited to, a data processing system (e.g., computer), a mobile device (e.g., a mobile phone, a mobile or portable computer, laptop, or tablet), a personal digital assistant, a wearable computing device (e.g., a smart watch and/or smart glasses), a gaming device, a set-top box, a television or other display device, appliance, or the like.

In the example, pipeline 100 includes a bounding box generator 102, a merge framework 104, and an image processor 106. In one or more example implementations, pipeline 100 may be implemented as one or more hardware processors (e.g., a central processing unit (CPU), a graphics processing unit (GPU), a digital signal processor (DSP), or any combination thereof), one or more application-specific integrated circuits (ASICs), or a combination of one or more hardware processors and one or more ASICs).

A digital image 110 may be provided to bounding box generator 102. Bounding box generator 102 is capable of performing object detection on digital image 110 and creating a bounding box for each object detected in digital image 110. For purposes of illustration, bounding box generator 102 may be capable of detecting objects such as persons, vehicles, and/or text. Bounding box generator 102 may output a plurality of bounding boxes 112, e.g., N different bounding boxes where each bounding box of the N bounding boxes encompasses a different detected object. In general, a one-to-one relationship exists between each of bounding boxes 112 and the detected objects. That is, for N objects detected, each object is encompassed or bound by its own bounding box bounding box as generated by bounding box generator 102.

Bounding boxes 112 are provided to merge framework 104. Merge framework 104 is capable of combining one or more pairs of bounding boxes to generate resulting bounding box(es) 114. Bounding box(es) 114 will include M bounding boxes where M<N. In some examples, M=1. The resulting bounding box(es) 114 may be provided to image processor 106. Image processor 106 also may receive digital image 110 for processing in combination with bounding boxes 114.

In general, image processor 106 is capable of operating on each bounding box 114 individually, whether sequentially or in parallel using a plurality of parallel threads/processes. Accordingly, one may observe that the number of bounding boxes 112 (e.g., N bounding boxes), while likely thorough for purposes of object detection, may not be ideal for purposes of reducing processing time by image processor 106 and/or may not be ideal for performing real-time image processing particularly where pipeline 100 is implemented in a device with limited computing resources and/or in situations where real-time image processing is required. That is, the number of bounding boxes 112 may be too large for the device to efficiently process digital image 110 and/or process digital image 110 in real-time. The number of bounding boxes 114 (e.g., M) may be set to a target number that is manageable by the device and/or is suitable for performing real-time image processing.

For purposes of illustration, consider the case where bounding box generator 102 is a text detector that is capable of outputting a bounding box for each single character that is detected. Some digital images may have a large corpus of text resulting in a large number of bounding boxes 112 (e.g., hundreds or thousands). This places a heavier burden on the computing device to perform image processing. In such cases, merge framework 104 is capable of reducing the number of bounding boxes to facilitate real-time processing by the device. In one or more embodiments, merge framework 104 is capable of generating a bounding box hierarchy as a tree data structure where leaf nodes contain a set of original bounding boxes and non-leaf nodes represent a merging operation of their children. In the case of a bounding box hierarchy, subsequent processing stages may select a certain level of the bounding box hierarchy based on how many bounding boxes are needed.

Image processor 106 is capable of performing one or more image processing functions. In an example, image processor 106 may perform an upscaling image processing operation and may perform the operation on each of the M bounding box(es) 114 individually. The upscaling, for example, may employ an object-specific technique to each of the M bounding box(es) 114. The resulting digital image is illustrated as processed digital image 116. Processed digital image 116 may be upscaled, for example, with specific image processing operations (e.g., object-specific upscaling) having been applied to each of the M bounding box(es) that may differ from the image processing (e.g., type of upscaling) applied to regions outside of the M bounding box(es) of the digital image.

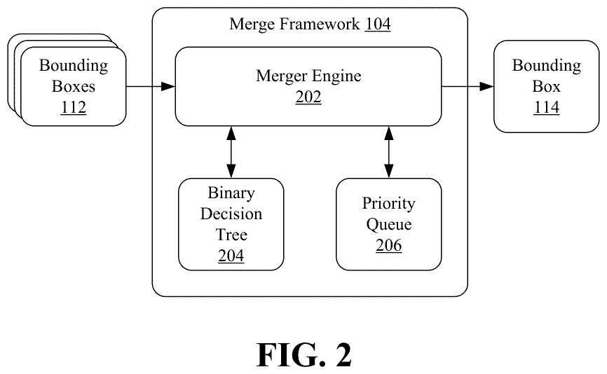

FIG. 2 illustrates merge framework 104 in accordance with one or more embodiments of the disclosed technology. In one or more embodiments, merge framework 104 is implemented as an executable framework that may be implemented as program instructions and executed by computer hardware such as a hardware processor. In one or more other embodiments, merge framework 104 may be implemented as dedicated circuitry or a combination of dedicated circuitry and program code. As generally noted in connection with FIG. 1, merge framework 104 is capable of merging or combining two or more bounding boxes of a plurality of bounding boxes generated from a digital image resulting in fewer bounding boxes or, in some cases, a single bounding box.

In the example of FIG. 2, merge framework 104 includes a merger engine 202, a binary search tree 204, and a priority queue 206. Binary search tree 204 and priority queue 206 may be implemented as data structures stored in physical memory circuitry. Merger engine 202 may be implemented as a hardware processor or as ASIC circuitry. Operation of merge framework 104 is described in greater detail hereinbelow with reference to the remaining Figures. In general, merger engine 202 utilizes the binary search tree 204 and priority queue 206 data structures to facilitate efficient and/or real-time operation. For example, binary search tree 204 is utilized to maintain and track the bounding box hierarchy as bounding boxes are merged, which requires inserting newly created bounding boxes and/or deleting merged bounding box pairs. Priority queue 206 is utilized to maintain and track distances between pairs of bounding boxes for purposes of selecting bounding box pairs for merging. In one or more other embodiments, one or more other data structures may be used to track certain aspects of the merger process(es) described herein.

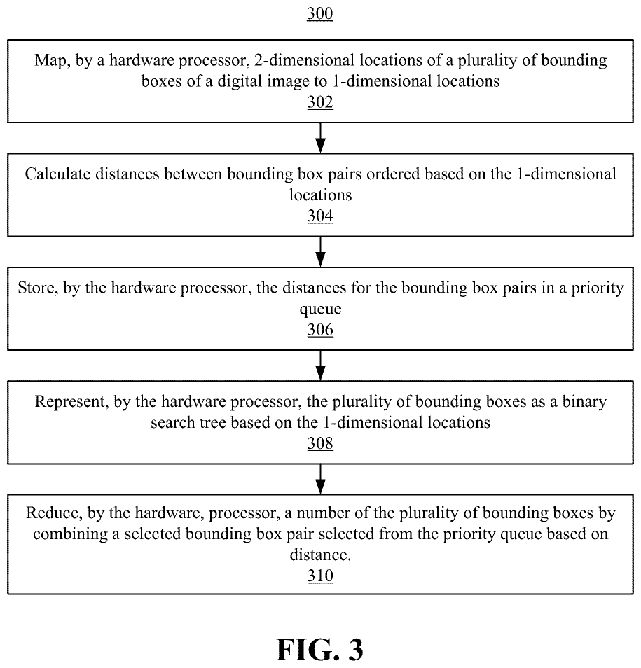

FIG. 3 illustrates a method 300 of operation for merge framework 104 in accordance with one or more embodiments of the disclosed technology. Method 300 may begin in a state where a plurality of bounding boxes 112 have been generated for a given digital image and provided to merge framework 104. As discussed, the plurality of bounding boxes 112 may include N bounding boxes. Method 300 may be performed on an iterative basis to process one or more additional digital images (e.g., individual digital images and/or frames of video) in real-time.

In general, each bounding box may be specified as a rectangular area that may be characterized by the coordinates of the top-left corner and the bottom-right corners. The bounding boxes are specified as 2D rectangles. Further, the coordinates of the top-left corner and the bottom-right corner of the bounding boxes may be specified using a 2D space or coordinate system overlaid on the digital image 110 being processed. The merger process implemented by merge framework 104 seeks to select two bounding boxes with a minimum distance and merge the two selected bounding boxes. This may be performed iteratively until only a predetermined number M of bounding boxes remains where M is less than N. Method 300 is also capable of generating a hierarchical structure of bounding box sets.

In block 302, merge framework 104 is capable of mapping 2D locations of the bounding boxes 112 to 1D locations. In one or more embodiments, merger engine 202 is capable of performing the mapping using a Morton code. In mapping the N bounding boxes to 1D coordinates, merger engine 202 is capable of computing approximate minimum distance pairs in local neighborhoods of bounding boxes. This process reduces the computational cost of finding two candidate bounding boxes for purposes of merging.

For example, merger engine 202 is capable of calculating the Morton code of the 2D coordinate of the center of each bounding box of the N bounding boxes. Merger engine 202 is also capable of sorting the bounding boxes based on the Morton code for each. By using the 2D to 1D coordinate mapping and sorting, a neighborhood query that determines the neighbor bounding boxes for a selected bounding box may be performed in constant time.

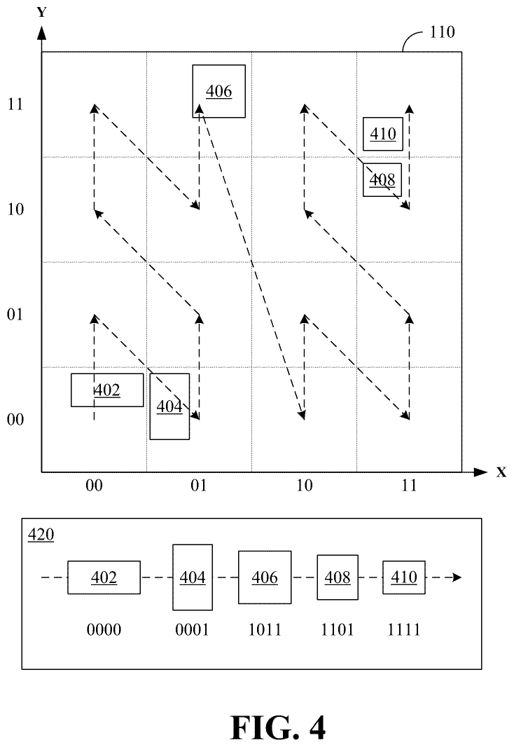

FIG. 4 illustrates an example implementation of the mapping process performed by merger engine 202 in accordance with one or more embodiments of the disclosed technology. In the example, there are five bounding boxes 402, 404, 406, 408, and 410 (e.g., N=5). The bounding boxes are placed over detected objects in digital image 110 using the (x, y) coordinate system illustrated (e.g., a 2D coordinate system).

In the example of FIG. 4, a Morton code for each bounding box may be generated. Using Morton codes, also referred to as “Z-order,” maps multidimensional data to one dimension while preserving locality of the data points. The z-value of a point in 2D may be calculated by interleaving the binary representations of the coordinate values of the 2D point. Following coordinates in increasing numerical order produces the recursively Z-shaped curve illustrated in the dashed line going from the lower left corner to the upper right corner. The time complexity of calculating Morton codes is O(N). In the example of FIG. 4, for purposes of illustration, the bottom left point of the coordinate system is designated as the origin.

The example of FIG. 4 illustrates that each of the bounding boxes 402-410 is assigned a Morton code based on the location of the respective bounding box. For example, the center of each bounding box may be used as the 2D coordinate of the bounding box that is to be mapped to the 1D location. The assignment of a Morton code to a bounding box maps the 2D coordinate of the center of the bounding box to a 1D coordinate. Sorting of the bounding boxes may be performed based on the Morton codes and is illustrated in block 420 where the bounding boxes have been sorted. In one or more embodiments, the N bounding boxes, as arranged using the 1D coordinates, naturally produce pairings. From block 420, it may be seen that for N bounding boxes, N-1 pairs of bounding boxes may be formed. For example, the following pairs of bounding boxes may be formed based on the sorted list of bounding boxes: (402, 404), (404, 406), (406, 408), and (408, 410).

In block 304, merge framework 104 is capable of calculating distances between bounding box pairs ordered based on the 1D locations. In block 304, merge framework 104 is capable of calculating a distance between the bounding boxes for each of the bounding box pairs. Merge framework 104, for example, calculates the distances between: (402, 404), (404, 406), (406, 408), and (408, 410) resulting in N-1 distances.

In the following example, the top left point of the coordinate system, which differs or is inverted from the example of FIG. 4, is considered the origin (0,0) with each axis using an increasing numeric scale. In other words, while FIG. 1 is illustrated using quadrant I, the example below is illustrated using quadrant IV albeit with both the x-axis and the y-axis using increasing positive numbers moving out from the origin.

In the example of calculating distance between two bounding boxes bᵢ and bⱼ of a bounding box pair illustrated below, each bounding box may be represented by top-left (tl) and bottom-right (br) coordinates as (xᵢ^{tl}, yᵢ^{tl}, xᵢ^{br}, yᵢ^{br}) and (xⱼ^{tl}, yⱼ^{tl}, xⱼ^{br}, yⱼ^{br}), respectively. As part of calculating distance in block 304, merger engine 202 is capable of calculating the coordinate of the bounding box bⱼ that encompasses bounding boxes bᵢ and bⱼ. Bounding box bᵢⱼ is the new bounding box created by merging bounding boxes bᵢ and bⱼ. The top-left and bottom right coordinates of the bounding box bᵢⱼ may be calculated as follows:
xᵢⱼ^{tl}=min(xᵢ^{tl}, xⱼ^{tl})
yᵢⱼ^{tl}=min(yᵢ^{tl}, yⱼ^{tl})
xᵢⱼ^{br}=max(xᵢ^{br}, xⱼ^{br})
xᵢⱼ^{br}=max(yᵢ^{br}, yⱼ^{br})

Merger engine 202 is capable of calculating the area of bounding box bⱼ as aᵢ, the area of bounding box bⱼ as aⱼ, and the area of bounding box bᵢⱼ as dᵢⱼ. Merger engine 202 is then capable of calculating the distance dᵢⱼ between bounding boxes bᵢ and bⱼ using the expression

$${d}_{ij} = {a}_{ij} - {a}_{i} - {a}_{j} .$$

Using the expression for calculating distance, the resulting distance may be a positive value, zero, or a negative value depending on whether bounding boxes b and bⱼ are far (positive), joint (zero), or overlapping (negative), respectively. Because the distance is used for purposes of comparing the distance between multiple bounding box pairs, non-positive values pose no issue. Normalizing the distance by the area of the union of bounding boxes bᵢ and bⱼ is omitted since the goal is to merge two bounding boxes to minimize the uncovered area of the image after the merge.

Example 1 below illustrates the procedure for calculating the distance between two bounding boxes bᵢ and bⱼ described above. Example 1 may be implemented as a function such as “CalDist(bᵢ and bⱼ) as performed by merger engine 202.

### Example 1

```
Input: two bounding boxes bᵢ and bⱼ
Output: distance dᵢⱼ between bᵢ and bⱼ
  1. Calculate the bounding box bᵢⱼ of bᵢ and bⱼ;
  2. Calculate the area of bᵢⱼ, bᵢ, and bⱼ as bᵢⱼ, aᵢ, and aⱼ;
  $3. return {d}_{ij} = {a}_{ij} - {a}_{i} - {a}_{j} ;$
```

In block 306, merge framework 104, e.g., merger engine 202, is capable of storing the distances for the bounding box pairs in priority queue 206. Priority queue 206 is capable of storing a plurality of entries where each entry includes a distance, as calculated in block 304, between a bounding box pair and an identifier (e.g., an index) of each of bounding boxes bᵢ and bⱼ. For example, each entry in the priority queue will specify: dᵢⱼ, bᵢ, and bⱼ. In one or more embodiments, priority queue 206 is configured to prioritize entries based on minimum distance such that the entry having the smallest or minimum distance may be popped from the priority queue. In other words, the bounding box pair having the minimum distance may be determined based on the distances stored therein and popped from priority queue 206. In using priority queue 206, merger engine 202 is capable of finding the bounding box pair with minimum distance with a time complexity of O(logN).

In block 308, merge framework 104, e.g., merger engine 202, is capable of representing, by the hardware processor, the plurality of bounding boxes as binary search tree 204 based on the 1-dimensional locations. Binary search tree 204 is capable of representing a plurality of bounding boxes to efficiently implement operations such as querying, insertion, and deletion of bounding boxes. Operations such as querying, insertion, and deletion may be performed using binary search tree 204 with a time complexity of O(logN).

In block 310, merge framework 104, e.g., merger engine 202, is capable of reducing the number N of bounding boxes 112 by combining one or more selected bounding box pairs as selected from priority queue 206 based on distance.

In one or more embodiments, the reducing the number of bounding boxes 112 includes updating binary search tree 204 by removing each bounding box of the selected bounding box pair from binary search tree 204, mapping a 2D location of the new bounding box to a 1D location, and adding the new bounding box to binary search tree 204 based on the 1D location. Reducing the number of bounding boxes also may include updating the priority queue by calculating a distance for each of one or more bounding box pairs that include the new bounding box and a neighbor bounding box as ordered based on the 1-dimensional locations and pushing an entry specifying a distance and a bounding box pair onto the priority queue for each of the one or more bounding box pairs including the new bounding box. The reduction operation may be performed iteratively to iteratively reduce the number of the plurality of bounding boxes.

In some aspects, the mapping 2D locations of the plurality of bounding boxes to 1D locations may be based on a Morton code. In some aspects, the priority queue prioritizes entries specifying smaller (e.g., minimum) distances over entries specifying larger distances. In some aspects, the selected bounding box pair is selected by popping an entry specifying a minimum distance from the priority queue.

As noted, the digital image may undergo further processing that utilizes the reduced bounding box set or the bounding box hierarchy that is generated. For example, digital image 110 may be upscaled based on a resulting number of bounding boxes remaining subsequent to the reduction in the number of the plurality of bounding boxes.

The example of FIG. 3 is provided for purposes of illustration. FIG. 3 illustrates a simplified example in which the bounding box pairs are generated from the sequential ordering of bounding boxes using the 1D coordinates. In one or more other embodiments, a range value of “r” may be specified. The range specifies a search range for creating bounding box pairs for each bounding box.

Example 2 below illustrates a more detailed example of method 300.

### Example 2

Input: a set of bounding boxes B, neighbor search range r
Output: Bounding Box Hierarchy

| | |
|---|---|
| 1: | Compute Morton code for all the elements in B, add them to a binary |
| | search tree bst; |
| 2: | Initialize Priority Queue pq whose elements have the form (dᵢⱼ, indexᵢ, |
| | indexⱼ); |
| 3: | for all the bounding boxes b in bst do |
| 4: | for all the neighbors of b in the range r do |
| 5: | Calculate the distance dᵢⱼ, push (dᵢⱼ, i, j) into pq; |
| 6: | end for |
| 7: | end for |
| 8: | while \|bst\| > 1 do |
| 9: | Pop the element (dᵢⱼ, i, j) from pq; |
| 10: | Merge bᵢ and bⱼ to form bᵢⱼ; |
| 11: | Calculate the Morton code for bᵢⱼ, insert bᵢⱼ, into bst; |
| 12: | Calculate the distance between bᵢⱼ and its neighbors in range r, push |
| | the distance |
| | and idexes into pq; |
| 13: | Remove bᵢ and bⱼ from bst; |
| 14: | end while |
| 15: | The calculation of bst implies the Bounding Box Hierarchy; |

In Example 2, the value of “r” indicates a search range for locating neighbors. In using Morton code, the mapping of 2D coordinates to 1D coordinates is used to simplify or constrain the nearest neighbor search to increase computational efficiency. Because the mapped 1D coordinates are an approximation of the 2D coordinates, the number of neighbors considered may be increased using different values of “r” to increase the likelihood of generating a bounding box pair with minimum distance. For example, using only 1 neighbor as illustrated in FIG. 3 or only using 2 neighbors (previous and next) may or may not provide sufficient accuracy in finding the nearest neighbor of a given bounding box.

In one or more embodiments, other values of “r” may be specified. For purposes of illustration, consider the case where r-4. In this example, the range for bounding box 406 may include the two previous bounding boxes 402 (previous-previous) and 404 (previous) and the next two bounding boxes 408 (next) and 410 (next_next). This results in the generation of 4 entries for bounding box 406 that are pushed onto priority queue 206 corresponding to the bounding box pairs (406, 402), (406, 404), (406, 408), and (406, 410). In this example, priority queue 206 still sorts entries based on distance such that the entry for a given bounding box still will be available at the top of priority queue 206 to be popped. In one or more embodiments, an additional data structure may be included to track the bounding boxes of popped entries so that when another entry specifying a bounding box of a previously popped entry is popped, that entry is discarded.

The process described above increases the accuracy of the 1D mapping. Increasing the value of “r” beyond a given value, however, may increase the neighbor searching accuracy at the cost of increased computational burden on the device. Accordingly, the value of “r” may be set to achieve a balance between increased search accuracy and computational load placed on the device.

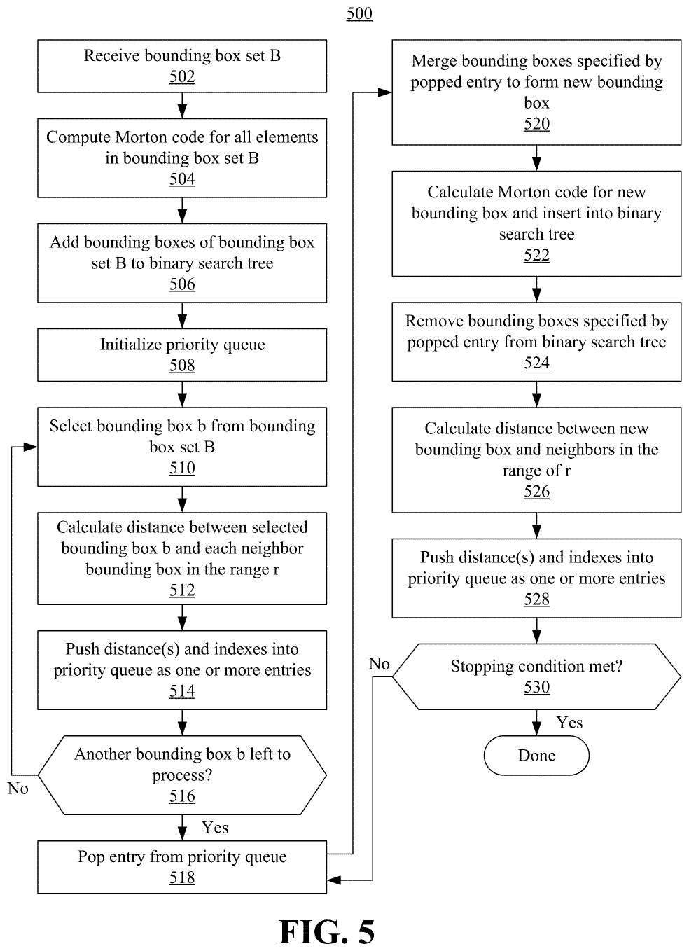

FIG. 5 illustrates a method 500 of generating a bounding box hierarchy in accordance with one or more embodiments of the disclosed technology. Method 500 is an example of a more detailed version of method 300 of FIG. 3 and generally corresponds to Example 2 above. Method 500 may be performed by merge framework 104 and, more particularly, by merger engine 202. In the example of FIG. 5, a range r may be specified as well as a desired number of resulting bonding boxes M as parameters used by method 500. In one or more embodiments, the value of M may be used as a stopping condition for discontinuing the merger process.

For purposes of illustration in the example of FIG. 5, both r and M may be set equal to 1. It should be appreciated that other values for r and/or M may be specified and that the values may be the same or may be different and independent of one another. As noted, in cases where M=1, a device may select any level of the resulting bounding box hierarchy based on the computational capabilities of the device and the real-time processing requirements. In other embodiments, to save additional time and/or computing resources, M may be set to a value less than N and larger than 1 so that the merger process ends in less time and produces a desired set of resulting bounding boxes that the device is capable of handling.

In block 502, merger engine 202 is capable of receiving bounding boxes 112 as the bounding box set B. In block 504, merger engine 202 is capable of computing the Morton code for all elements in bounding box set B. As such, merger engine 202 computes the Morton code for each bounding box b of the bounding box set B. As discussed, computing the Morton code for elements in bounding box set B translates the 2D coordinates of each bounding box into 1D coordinates while preserving locality of the bounding boxes. This mapping process allows merger engine 202 to calculate significantly fewer distances than would otherwise be the case thereby conversing computing resources and reducing runtime. As part of block 504, the bounding boxes may be sorted based on their 1D locations.

In block 506, merger engine 202 is capable of adding each bounding box b of the bounding box set B to binary search tree 204. As discussed, each bounding box b may be added based on the 1D coordinate of that bounding box. In this respect, a node of binary search tree 204 representing a bounding box may specify the 1D coordinate of the bounding box being represented. In block 508, merger engine 202 is capable of initializing priority queue 206. As discussed, each element, or entry, in priority queue 206 may be formed of a distance calculated between two bounding boxes (e.g., a bounding box pair) and the identifying index for each bounding box in the bounding box pair.

In block 510, merger engine 202 is capable of selecting a bounding box from the bounding box set B. In block 512, merger engine 202 is capable of calculating the distance between the selected bounding box and each neighbor bounding box in the range r of the selected bounding box. In block 514, merger engine 202 is capable of pushing the distance(s) and indexes into priority queue 206 as one or more entries (e.g., one entry for each pair). In this example, as the range r is set to 1, at most one entry is created in priority queue 206 for each selected bounding box. As noted, in other examples, the range may be set to 2, 3, 4, etc. In block 516, merger engine 202 determines whether there are any further bounding boxes left to process. In response to determining that no further bounding boxes remain to be processed, method 500 continues to block 518. In response to determining that one or more bounding boxes remain to be processed, method 500 loops back to block 510 to continue processing.

For purposes of illustration in reference to blocks 510-516, and referring to block 420 of FIG. 4 (e.g., with r=1 and using “next” bounding boxes), in the first iteration bounding box 402 may be selected. As noted, the bounding boxes may be sorted based on 1D locations. In that case, merger engine 202 calculates the distance between bounding box 402 and the neighbor bounding box of bounding box 402, which is bounding box 404. Merger engine 202 pushes an entry specifying the distance between bounding boxes 402 and 404, an index specifying bounding box 402, and an index specifying bounding box 404 onto priority queue 206. In the next iteration, with bounding box 404 being the selected bounding box, merger engine 202 calculates the distance between bounding boxes 404 and 406, where bounding box 406 is the neighbor bounding box of bounding box 404. Merger engine 202 pushes an entry specifying the distance between bounding boxes 404 and 406, an index specifying bounding box 404, and an index specifying bounding box 406 onto priority queue 206. In the next iteration, with bounding box 406 being the selected bounding box, merger engine 202 calculates the distance between bounding boxes 406 and 408, where bounding box 408 is the neighbor bounding box of bounding box 406. Merger engine 202 pushes an entry specifying the distance between bounding boxes 406 and 408, an index specifying bounding box 406, and an index for bounding box 408 onto priority queue 206. In the next iteration, with bounding box 408 being the selected bounding box, merger engine 202 calculates the distance between bounding boxes 408 and 410, wherein bounding box 410 is the neighbor bounding box of bounding box 408. Merger engine 202 pushes an entry specifying the distance between bounding boxes 408 and 410, an index specifying bounding box 408, and an index for bounding box 410 onto priority queue 206.

Starting in block 518, merger engine 202 begins processing entries in priority queue 206, which is sorted so that the entry having the minimum distance is at the top and may be popped. In block 518, merger engine 202 pops an entry from priority queue 206. The entry that is popped will be the entry having the minimum distance.

In one or more embodiments, in cases where r>1, a checking mechanism may be included (not shown) to ensure that entries popped from priority queue 206 that specify a previously processed bounding box (e.g., that specify a bounding box from a previously popped entry) are discarded. For example, merger engine 202 is capable of assigning an index to each of the N bounding boxes. Each time two bounding boxes are merged, the new bounding box is assigned a new and unique index. For example, if N=100 with indexes of 0-99, the first newly created bounding box may be assigned an index of 100.

Merger engine 202 is capable of tracking the index of each bounding box specified by an entry popped from priority queue 206 in a further data structure. The data structure stores the set of indexes of bounding boxes specified by previously popped entries. Each time an entry is popped from priority queue 206, merger engine 202 is capable of checking whether either one of the bounding boxes specified by the popped entry is in the set of bounding boxes specified by the data structure. In response to detecting that one or both of the bounding boxes of the popped entry are specified in the data structure, merger engine 202 discards the popped entry. If only one of the bounding boxes is listed in the set, merger engine 202 adds the index of the other bounding box to the set. In response to determining that neither bounding box of the popped entry is specified in the data structure, the index of each bounding box from the popped entry is added to the set and method 500 may continue processing the popped entry.

In block 520, merger engine 202 merges the two bounding boxes, e.g., the bounding box pair, specified by the popped entry to form a new bounding box. In block 522, merger engine 202 is capable of calculating a Morton code for the new bounding box created in block 520 and inserts the bounding box into the binary search tree at a location corresponding to the Morton code. In block 524, merger engine 202 is capable of removing the bounding boxes specified in the popped entry that were merged from binary search tree 204.

In block 526, merger engine 202 is capable of calculating distance(s) between the new bounding box and each neighbor bounding box in the range r. In one or more embodiments, the neighbors of the new bounding box are determined based on the sorted Morton codes of the bounding boxes. Distances may be calculated using the center of each bounding box of a bounding box pair.

In one or more examples, binary search tree 204 may be implemented using any of a variety of software libraries that provide functions such as querying, insertion, and deletion of binary search tree data structures. In one or more embodiments, the library may provide functions for returning adjacent bounding boxes (e.g., nodes). For example, as binary search tree 204 may be constructed using the 1D coordinate of each bounding box, the elements of binary search tree 204 may be indexed as a list sorted in order of the 1D coordinates. This sorting may be performed or maintained for each iteration (e.g., updated once any new bounding box is added and merged bounding boxes are removed). The library may provide functions for obtaining the index of any element therein and, given that index, the element having index+1, index+2, etc. (one or more a neighbor bounding box(es)) and the element having index−1, index−2, etc. (one or more other neighbor bounding box(es)). These functions allow for fast and efficient determination of neighbor(s) of any given bounding box as binary search tree 204 continues to change through insertion and/or deletion operations.

In block 528, merger engine 202 is capable of pushing an entry for each newly calculated distance for the new bounding box (e.g., from block 526) onto priority queue 206 with the corresponding indices specifying the particular bounding box pair to which each distance corresponds.

In block 530, merger engine 202 is capable of determining whether a stopping condition is met. In one or more embodiments, the stopping condition compares the number of remaining bounding boxes with the value of M. In response to determining that the number of remaining bounding boxes subsequent to the merge operation exceeds the value of M, method 500 may loop back to block 518 to pop a further entry from priority queue 206 and continue processing to perform another merge operation. In response to determining that the number of remaining bounding boxes subsequent to the merge operation is less than or equal to the value of M, method 500 may end.

At the conclusion of method 500, the remaining bounding boxes as specified in the binary search tree are the bounding box hierarchy that is generated. In one or more embodiments, the bounding box hierarchy may preserve the underlying hierarchy of bounding boxes created as method 500 iterates. In one or more other embodiments, the underlying hierarchy need not be preserved. Whether the underlying bounding box hierarchy is preserved may be specified based on whether that hierarchy is useful given the particular use case or context in which the bounding box merger operations are performed.

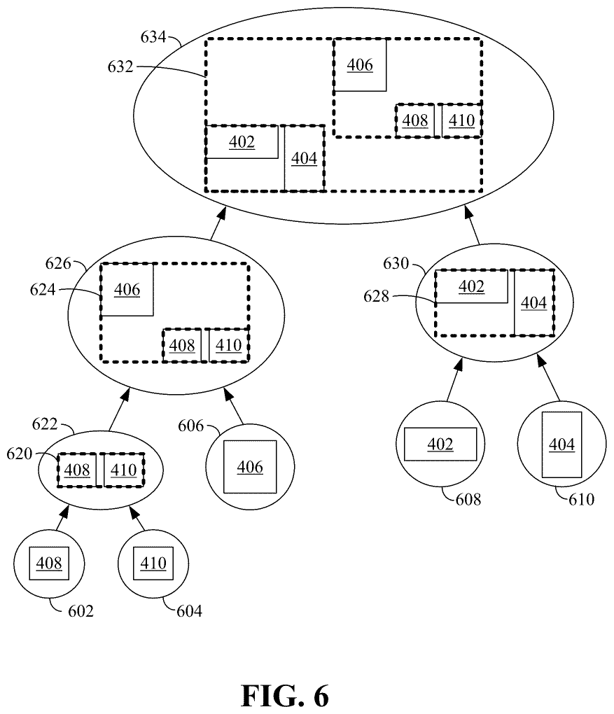

FIG. 6 is an example visual illustration of the process described in connection with Example 2 and/or FIG. 5. For ease of illustration, r is set equal to 1. In the example, merger engine 202 is capable of adding nodes 602, 604, 606, 608, and 610 corresponding to bounding boxes 408, 410, 406, 402, and 404, respectively, to binary search tree 204. As method 500 iterates from block 518 to block 530 in the case where M=1, merger engine 202 beings merging pairs of bounding boxes.

For purposes of illustration, in a first iteration through blocks 518-530, merger engine 202 is capable of popping an entry from priority queue 206 specifying bounding boxes 408 and 410. Accordingly, merger engine 202 merges bounding boxes 408 and 410 to form a new bounding box 620, which is added to binary search tree 204 as node 622.

In a second iteration through blocks 518-530, merger engine 202 is capable of popping an entry from priority queue 206 specifying bounding boxes 402 and 404. Accordingly, merger engine 202 merges bounding boxes 402 and 404 to form new bounding box 628 which is added to binary search tree 204 as node 630.

In a third iteration through blocks 518-530, merger engine 202 is capable of popping an entry from priority queue 206 specifying bounding boxes 620 and 406. Accordingly, merger engine 202 is capable of merging bounding box 620 and bounding box 406 to form a new bounding box 624, which is added to binary search tree 204 as node 626.

In a fourth iteration through blocks 518-530, merger engine 202 is capable popping an entry from priority queue 206 specifying bounding boxes 624 and 628. Accordingly, merger engine 202 merges bounding box 624 and bounding box 628 to form a new bounding box 632, which is added to binary search tree 204 as node 634. At this point, the number of remaining bounding boxes is equal to 1 (e.g., M=1) and merger engine 202 may discontinue the merging operations.

The resulting bounding box hierarchy is illustrated in node 634. In the example, node 634 preserves the bounding box hierarchy that was created through each of the iterations described. That is, each of bounding boxes 402, 404, 406, 408, 410, 620, 624, and 628 is preserved beneath bounding box 632 in node 634. This allows an application and/or device to select any level within the hierarchy based on the number of bounding boxes that device can process while meeting performance requirements. As noted, in other embodiments, the merging may stop prior to merging the bounding boxes to a single bounding box. In still other examples, only bounding box 632 or the bounding boxes generated when the stopping condition is met need be preserved and output rather than preserving any hierarchy within any bounding boxes that remain.

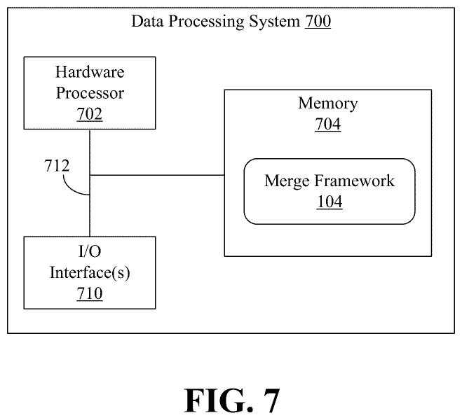

FIG. 7 illustrates an example of a data processing system 700. As used herein, “data processing system” refers to one or more hardware systems capable of processing data. Each hardware system may include one or more hardware processors and memory.

Data processing system 700 includes a hardware processor 702. Hardware processor 702 may be implemented as one or more hardware processors. Hardware processor 702 may be implemented as one or more circuits capable of executing computer-readable program instructions (program instructions). The circuit(s) may comprise integrated circuits (ICs) or may be embedded within an IC. In one or more examples, hardware processor 702 may be embodied as a CPU, a GPU, a DSP, a programmable IC, an ASIC, or any combination thereof.

In some embodiments, hardware processor 702 may include one or more cores, for example, where each core is capable of executing computer-readable program instructions. Hardware processor 702 may be implemented using any of a variety of architectures such as, for example, a complex instruction set computer architecture (CISC), a reduced instruction set computer architecture (RISC), a vector processing architecture, or other known architectures. For example, a hardware processor may be implemented using an x86 architecture (e.g., IA-32, IA-64), a Power Architecture, as an ARM processor, or the like.

Data processing system 700 can include memory 704. Memory 704 may be embodied as one or more computer-readable storage mediums. Memory 704 may include volatile memory and non-volatile memory. Volatile memory may be embodied as random-access memory (RAM) and may include cache memory. Volatile memory may be referred to as “runtime memory.” Non-volatile memory may include a non-volatile magnetic medium and/or a solid-state medium (typically called a “hard drive”). Non-volatile memory is characterized by the ability to continue to store data regardless of whether power is supplied to the memory. Non-volatile memory also may include one or more disk drives capable of reading from and writing to various types of removable, non-volatile mediums such as a removable, non-volatile magnetic disk (e.g., a “floppy disk”) and/or a removable, non-volatile optical disk such as a CD-ROM, DVD-ROM or other optical media.

Memory 704 is capable of storing program instructions and/or data such that hardware processor 702 is capable of executing the program instructions to perform one or more operations as described within this disclosure. For example, the program instructions can include an operating system, one or more application programs, other program code, and program data. Examples of the program instructions may include an image processing pipeline including merge framework 104. Hardware processor 702, in executing the computer-readable program instructions implementing merge framework 104, is capable of performing the various operations described herein.

Data processing system 700 may include one or more Input/Output (I/O) interfaces 710. I/O interface(s) 710 allow data processing system 700 to communicate with one or more external devices and/or communicate over one or more networks such as a local area network (LAN), a wide area network (WAN), and/or a public network (e.g., the Internet). Examples of I/O interfaces 710 may include, but are not limited to, network cards, modems, network adapters (wired and/or wireless), hardware controllers, etc. Examples of external devices also may include devices that allow a user to interact with data processing system 700 (e.g., a display, a keyboard, and/or a pointing device) and/or other devices such as accelerator card.

Bus 712 represents one or more of any of a variety of communication bus structures. By way of example, and not limitation, bus 712 may be implemented as a Peripheral Component Interconnect Express (PCIe) bus. Bus 712 couples to each of hardware processor 702, memory 704, and I/O interface(s) 710 through respective interface circuitry thereby allowing the devices to communicate. Bus 712 may represent a plurality of buses that may be interconnected and/or hierarchically organized.

Data processing system 700 is only one example implementation. Data processing system 700 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

The example of FIG. 7 is not intended to suggest any limitation as to the scope of use or functionality of example implementations described herein. Data processing system 700 is an example of computer hardware that is capable of performing the various operations described within this disclosure. In this regard, data processing system 700 may include fewer components than shown or additional components not illustrated in FIG. 7 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

In one or more other examples, data processing system 700 may be embodied as a mobile computing device, a wearable computing device, or any of the various computing devices described herein. It should be appreciated that depending on the particular device being implemented, data processing system 700 may include fewer or additional components, different types of I/O interfaces (e.g., wireless and/or mobile transceivers), different types of displays, and/or different types of other peripherals.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of a computer readable storage mediums. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “output” means storing in physical memory elements, e.g., devices, writing to a display or other peripheral output device, sending or transmitting to another system, exporting, or the like.

Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), and a controller.

As defined herein, the term “real-time” means a level of processing responsiveness that a user or system senses as sufficiently immediate for a particular process or determination to be made, or that enables the processor to keep up with some external process.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or two or more, e.g., a plurality, of such mediums) having computer readable program instructions thereon for causing a processor to carry out aspects of the present disclosed technology. Within this disclosure, the term “program code” is used interchangeably with the terms “computer readable program instructions” and “program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A method, comprising:
mapping, by a hardware processor, 2-dimensional locations of a plurality of bounding boxes of a digital image to 1-dimensional locations;
calculating distances between bounding box pairs sorted based on the 1-dimensional locations;
storing, by the hardware processor, entries in a priority queue, wherein each entry specifies a bounding box pair and a distance between the bounding box pair;
representing, by the hardware processor, the plurality of bounding boxes as a binary search tree based on the 1-dimensional locations; and
reducing, by the hardware processor, a number of the plurality of bounding boxes by merging a selected bounding box pair selected from the priority queue based on distance, wherein the merging creates a new bounding box.

2. The method of claim 1, wherein the reducing comprises updating the binary search tree by:
removing each bounding box of the selected bounding box pair from the binary search tree;
mapping a 2-dimensional location of the new bounding box to a 1-dimensional location; and
adding the new bounding box to the binary search tree based on the 1-dimensional location.

3. The method of claim 2, wherein the reducing comprises updating the priority queue by:
calculating a distance for each of one or more bounding box pairs that include the new bounding box and a neighbor bounding box as ordered based on the 1-dimensional locations; and
pushing an entry specifying a distance and a bounding box pair onto the priority queue for each of the one or more bounding box pairs including the new bounding box.

4. The method of claim 3, further comprising:
iteratively reducing the number of the plurality of bounding boxes.

5. The method of claim 1, wherein the mapping 2-dimensional locations of the plurality of bounding boxes to 1-dimensional locations is based on a Morton code.

6. The method of claim 1, wherein the priority queue prioritizes entries specifying smaller distances over entries specifying larger distances.

7. The method of claim 1, wherein the selected bounding box pair is selected by popping an entry specifying a minimum distance from the priority queue.

8. The method of claim 1, further comprising:
upscaling the digital image based on a resulting number of bounding boxes remaining subsequent to the reducing the number of the plurality of bounding boxes.

9. An apparatus, comprising:
a hardware processor configured to perform operations including:
mapping 2-dimensional locations of a plurality of bounding boxes of a digital image to 1-dimensional locations;
calculating distances between bounding box pairs sorted based on the 1-dimensional locations;
storing entries in a priority queue, wherein each entry specifies a bounding box pair and a distance between the bounding box pair;
representing the plurality of bounding boxes as a binary search tree based on the 1-dimensional locations; and
reducing a number of the plurality of bounding boxes by merging a selected bounding box pair selected from the priority queue based on distance, wherein the merging creates a new bounding box.

10. The apparatus of claim 9, wherein the reducing comprises updating the binary search tree by:
removing each bounding box of the selected bounding box pair from the binary search tree;
mapping a 2-dimensional location of the new bounding box to a 1-dimensional location; and
adding the new bounding box to the binary search tree based on the 1-dimensional location.

11. The apparatus of claim 10, wherein the reducing comprises updating the priority queue by:
calculating a distance for each of one or more bounding box pairs that include the new bounding box and a neighbor bounding box as ordered based on the 1-dimensional locations; and
pushing an entry specifying a distance and a bounding box pair onto the priority queue for each of the one or more bounding box pairs including the new bounding box.

12. The apparatus of claim 11, wherein the hardware processor is configured to perform operations further comprising:
iteratively reducing the number of the plurality of bounding boxes.

13. The apparatus of claim 10, wherein the mapping 2-dimensional locations of the plurality of bounding boxes to 1-dimensional locations is based on a Morton code.

14. The apparatus of claim 10, wherein the priority queue prioritizes entries specifying smaller distances over entries specifying larger distances.

15. The apparatus of claim 10, wherein the selected bounding box pair is selected by popping an entry specifying a minimum distance from the priority queue.

16. The apparatus of claim 10, further comprising:
upscaling the digital image based on a resulting number of bounding boxes remaining subsequent to the reducing the number of the plurality of bounding boxes.

17. A computer program product, comprising:
one or more computer readable storage mediums, and program instructions collectively stored on the one or more computer readable storage mediums, wherein the program instructions are executable by computer hardware to initiate operations including:
mapping 2-dimensional locations of a plurality of bounding boxes of a digital image to 1-dimensional locations;
calculating distances between bounding box pairs sorted based on the 1-dimensional locations;
storing entries in a priority queue, wherein each entry specifies a bounding box pair and a distance between the bounding box pair;
representing the plurality of bounding boxes as a binary search tree based on the 1-dimensional locations; and
reducing a number of the plurality of bounding boxes by merging a selected bounding box pair selected from the priority queue based on distance, wherein the merging creates a new bounding box.

18. The computer program product of claim 17, wherein the reducing comprises updating the binary search tree by:
removing each bounding box of the selected bounding box pair from the binary search tree;
mapping a 2-dimensional location of the new bounding box to a 1-dimensional location; and
adding the new bounding box to the binary search tree based on the 1-dimensional location.

19. The computer program product of claim 18, wherein the reducing comprises updating the priority queue by:
calculating a distance for each of one or more bounding box pairs that include the new bounding box and a neighbor bounding box as ordered based on the 1-dimensional locations; and
pushing an entry specifying a distance and a bounding box pair onto the priority queue for each of the one or more bounding box pairs including the new bounding box.

20. The computer program product of claim 17, wherein the mapping 2-dimensional locations of the plurality of bounding boxes to 1-dimensional locations is based on a Morton code.
